(19) United States
(12) Patent Application Publication
(10) Pub. No.: US 2010/0278706 A1
(43) Pub. Date: Nov. 4, 2010

(54) METHOD FOR REDUCING THE CONTENT IN ELEMENTS, SUCH AS BORON, IN HALOSILANES AND INSTALLATION FOR CARRYING OUT SAID METHOD

(75) Inventors: Ekkehard Mueh, Rheinfelden (DE); Hartwig Rauleder, Rheinfelden (DE); Reinhold Schork, Rheinfelden (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GmbH, Essen (DE)

(21) Appl. No.: 12/811,925

(22) PCT Filed: Nov. 20, 2008
(86) PCT No.: PCT/EP2008/065892

§ 371 Date: Jul. 7, 2010

(30) Foreign Application Priority Data
Jan. 14, 2008 (DE) 102008004397.4

(51) Int. Cl. C01B 33/107; B01J 19/00

(52) U.S. Cl. 423/342; 422/129; 422/187; 422/119

(57) ABSTRACT

The invention relates to a method for reducing the content in elements of the third main group of the periodic system, especially in boron- and/or aluminum-containing compounds of technically pure halosilanes for producing purified halosilanes, especially high-purity chlorosilanes. The invention further relates to an installation for carrying out said method.

The invention relates to a process for reducing the content of elements of the third main group of the Periodic Table, especially of boron and/or aluminium, in halosilanes of technical-grade purity to prepare purified halosilanes, especially ultrahigh-purity chlorosilanes. The invention further relates to a plant for performing this process.

The prior art discloses two processes for purifying halosilanes, which are based on the use of triphenyl-methyl chloride in conjunction with further complexing agents. One is the multistage process of GB 975 000, in which phosphorus-containing impurities in halosilanes are distillatively removed, first by adding tin tetrahalides and/or titanium tetrahalides to form solid precipitates. In the next step, triphenylmethyl chloride can be added in a large excess to the resulting distillate in order to form precipitates with tin salts or titanium salts, and also with any further impurities present, which also include boron, aluminium or other impurities. Distillation was effected in the following step.

WO 2006/054325 A2 discloses a multistage process for preparing electronics-grade silicon tetrachloride (Si_{eg}) or trichlorosilane from silicon tetrachloride or trichlorosilane of technical-grade purity. Proceeding from silicon tetrachloride and/or trichlorosilane of technical-grade purity, boron-containing impurities (BCl₃), among others, are converted to high-boiling complexes in a first step by adding diphenylthio-carbazone and triphenylchloromethane, and removed in the second step by means of column distillation, and phosphorus chlorides (PCl₃) and phosphorus-containing impurities, arsenic- and aluminium-containing impurities and further metallic impurities are removed as distillation residues in a second column distillation in the third step. It is stated that the use of two complexing agents is necessary to remove all impurities, because triphenylchloromethane allows the complexation of a multitude of metallic impurities with the exception of boron. Only in a fourth step is dichlorosilane removed by distillation.

It is an object of the present invention to develop a simpler and hence more economically viable process and a plant for preparing ultrahigh-purity halosilanes, especially chlorosilanes, which are suitable for production of solar silicon and especially also for production of semiconductor silicon.

The object is achieved by the process according to the invention and the inventive plant according to the features of claims 1 and 17. Preferred variants are described in the dependent claims.

The invention provides a process which allows the preparation of purified halosilanes from halosilanes of technical-grade purity, in which the elements of the third main group of the Periodic Table (III PTE), especially boron and/or aluminium, are removed virtually quantitatively. More particularly, ultrahigh-purity halosilanes are obtained.

The invention provides a process for reducing the content of elements of the third main group of the Periodic Table, especially the boron and/or aluminium content, in halosilanes of technical-grade purity to prepare purified halosilanes, comprising the following steps:
a) admixing the halosilanes to be purified with triphenylmethyl chloride to form complexes which are sparingly soluble in halosilanes, and
b) obtaining purified halosilanes by removing sparingly soluble complexes formed by means of mechanical action or mechanical measures.

Before the removal of the complexes by means of mechanical measures, the reaction mixture can be treated thermally, for example heated, in order to first coagulate the complexes which are generally obtained in flocculent form, such that they can be removed more easily. Preferably, ultrahigh-purity halosilanes are obtained. The removal of the precipitated complexes may be followed by a distillation step in order to further purify the halosilanes. Mechanical action or mechanical measures are understood to mean especially the following measures, such as filtration, sedimentation, decantation, skimming-off and/or centrifugation, preference being given to filtration. These measures can be performed batchwise or else continuously.

In one embodiment, the process according to the invention can be performed in such a way that step (a), the admixing of the halosilanes to be purified with triphenylmethyl chloride to form the complexes, is effected in an apparatus for complexation (2), from which the halosilanes and the complexes are transferred at least partly into a separating unit (3), especially into a separate separating unit (3), for removing the complexes in step (b). In this process regime, step (a) is therefore effected separately from step (b), especially spatially separately. In this separating unit (3), the removal is then preferably effected first by means of mechanical action, which may optionally be followed by a distillation of the halosilanes in order to obtain high-purity halosilanes, preferably high-purity tetrachlorosilane, trichlorosilane and/or dichlorosilane. According to the invention, steps (a) and (b) are incorporated into a continuous process for preparing ultrahigh-purity halosilanes, preferably proceeding from a conversion of metallurgical silicon.

The reason for the advantage of this process regime is that the complexation is separated from the removal and, in this way, the removal of elements of the third main group, such as boron and/or aluminium or compounds containing them, can be integrated into a continuous overall process. This can be done, for example, in such a way that at least one apparatus for complexation 2 is, preferably a plurality of apparatuses 2 connected in parallel are, assigned to a separating unit 3. The apparatus or apparatuses for complexation 2 may, for example, be filled with or flowed through by halosilanes batchwise or continuously—batch reactor or tubular reactor—and the content of elements of the third main group, such as boron, and optionally further impurities can be determined analytically. Subsequently, the halosilanes to be purified are admixed with triphenylmethyl chloride, preferably with a slight excess of ≦20 mol %, more preferably ≦10 mol %, most preferably of ≦5 mol % or less, in relation to the contamination with elements of the third main group of the PTE.

The resulting reaction mixture can be homogenized in order to ensure complete complexation, for example, of the boron-containing compounds. The homogenization can be effected by stirring or, in the tubular reactor, by vortexing. Subsequently, the halosilanes and, if appropriate, the complexes are transferred into the separating unit 3. This is advantageously followed therein firstly by a removal of the sparingly soluble complexes by mechanical measures and, if appropriate, subsequently a distillative workup of the purified halosilanes in order to obtain ultrahigh-purity halosilanes.

By virtue of the batchwise complexations performed semicontinuously or continuously and in parallel (step a) and of the subsequent removal of the halosilanes, the process according to the invention can be integrated into a continuous overall process for preparing ultrahigh-purity halosilanes proceeding from a hydrohalogenation of metallurgical silicon.

Elements in the third main group of the Periodic Table (IIIa PTE) which are relevant to the process, the content of which in the halosilanes of technical-grade purity is to be reduced, are especially boron and/or aluminium, and process-related compounds containing boron and/or aluminium. In general, the triphenylmethyl chloride can form complexes with all typical Lewis acids. These may, as well as boron and aluminium, also be tin, titanium, vanadium and/or antimony, or compounds containing these extraneous metals.

In appropriate embodiments, the process according to the invention can be performed in a wide variety of different ways. For instance, after the admixing of the halosilanes with triphenylmethyl chloride, the sparingly soluble complexes, for example in coagulated form, can first be removed by means of mechanical measures, for example by filtration or centrifugation. Before the mechanical removal, a thermal treatment may be advantageous; one possible treatment is to heat the reaction mixture in order to coagulate the sparingly soluble complexes and hence make them easier to remove and/or the reaction mixture is cooled in order to lower the solubility of the complexes further. For example, the reaction mixture can be cooled to about 0° C. or to temperatures in the range from 10° C. to −40° C. in order then to undertake the removal of the complexes. The removal by means of mechanical measures may be followed by a distillative purification of the halosilanes, for example a flash distillation using a tubular evaporator or a short-path column. Typically, the distillative purification, for example of the halosilanes silicon tetrachloride and/or trichlorosilane, is effected using a column at a top temperature of about 31.8° C. and 56.7° C. and a pressure of about 1013.25 hPa or 1013.25 mbar_{abs}. At higher or lower pressures, the top temperature changes correspondingly. Low boilers can appropriately be distilled under elevated pressure.

According to the later field of use of the purified halosilanes obtained, preferably of the ultrahigh-purity halosilanes, merely the sole removal of the sparingly soluble complexes by means of mechanical measures may be sufficient. This can preferably be done by a single or double filtration. The boron content in the ultrahigh-purity halosilanes obtained is especially ≦50 μm/kg, preferably 20≦μm/kg and more preferably ≦5 μm/kg of boron per kilogram of halosilane.

The process according to the invention comprising steps (a) and (b) can be integrated into a continuous process for preparing ultrahigh-purity halosilanes, especially proceeding from a hydrohalogenation of metallurgical silicon.

Halosilanes are preferably understood to mean chlorosilanes and/or bromosilanes, particular preference being given to silicon tetrachloride, trichlorosilane and/or mixtures of these silanes, optionally with further halogenated silanes, such as dichlorosilane and/or monochlorosilane. The process is therefore generally very suitable for reducing the content of elements of the third main group of the Periodic Table in halosilanes when the solubility of the complexes formed is correspondingly low and/or these compounds have a comparable boiling point or boiling point range to the halosilanes or would distil over as an azeotrope with the halosilanes. Some compounds containing elements of the third main group of the Periodic Table can therefore be removed from the halosilanes by distillation only with difficulty, if at all. A boiling point within the range of the boiling point of a halosilane is considered to be a boiling point which is within the range of ±20° C. of the boiling point of one of the halosilanes at standard pressure (about 1013.25 hPa or 1013.25 mbar).

Appropriately, the process can also be employed to purify tetrabromosilane, tribromosilane and/or mixtures of halosilanes. Generally, every halogen in the halosilanes may be selected independently from further halogen atoms from the group of fluorine, chlorine, bromine and iodine, such that, for example, mixed halosilanes such as SiBrCl₂F or SiBr₂ClF may also be present. In addition to these preferably monomeric compounds, it is, however, also possible to correspondingly reduce the boron content of dimeric or higher molecular weight compounds, such as hexachlorodisilane, decachlorotetrasilane, octachloro-trisilane, pentachlorodisilane, tetrachlorodisilane and liquid mixtures containing monomeric, dimeric, linear, branched and/or cyclic oligomeric and/or polymeric halosilanes.

Halosilanes of technical-grade purity are understood to mean contaminated halosilanes, especially halosilanes whose content of halosilanes is ≧97% by weight and which have a content of elements of the third main group; more particularly, the content of elements of the third main group of the Periodic Table is in each case up to 0.1% by weight; for example, the content is in the range from ≦0.1% by weight to ≧100 μg/kg per element. They preferably have at least a content of 99.00% by weight, for example a content of at least 99.9% by weight of the desired halosilane(s) and are contaminated by elements of the third main group as defined above. For example, the composition may have a content of 97.5% by weight of silicon tetrachloride and 2.2% by weight of trichlorosilane (HSiCl₃), or about 85% by weight of SiCl₄ and 15% by weight of HSiCl₃, or else 99.0% by weight of silicon tetrachloride.

Purified halosilanes are considered to be technical-grade halosilanes whose content of elements of the third main group of the Periodic Table has been reduced after performance of the process.

Ultrahigh-purity halosilanes are considered to be halosilanes with a content of halosilanes of 99.9% by weight, preferably of 99.99% by weight, of halosilane, and especially having a maximum contamination by any element of the third main group of the PTE, especially by boron- and also by aluminium-containing compounds, of ≦50 μg/kg in relation to the element per kilogram of halosilane, especially of ≦25 μg/kg, preferably of ≦20 μg/kg, ≦15 μg/kg or ≦10 μg/kg, particular preference being given to a contamination of ≦5 μg/kg, ≦2 μg/kg or ≦1 μg/kg per element in the halosilane, in accordance with the invention by each of boron and aluminium.

Boron-containing compounds are, for example, boron trichloride or boric esters. In general, however, all boron-containing compounds which are produced in the synthesis of the halosilanes or entrained into the processes can be reduced down to a residual content of especially—20 μg/kg, preferably of ≦5 μg/kg, ≦2 μg/kg, more preferably to ≦1 μg/kg, of boron per kilogram of halosilane. In general, boron and/or a boron-containing compound, depending on the starting concentration thereof, can be reduced by 50 to 99.9% by weight. The same applies to aluminium or to aluminium-containing compounds. A typical aluminium-containing compound is AlCl₃.

According to the invention, in process step a) of the process, the complex-forming compound triphenylmethyl chloride is preferably added in such an amount that the solubility product of the complex(es) of an element of the third main group of the Periodic Table (IIIa PTE) formed with triphenylmethyl chloride is exceeded, more particularly of the compounds containing this element, more preferably of the boron- and/or aluminium-containing compounds, and a precipitate of the complex(es) forms. It is particularly preferred that the amount of triphenylmethyl chloride added is such that this compound is added only in a slight excess of about ≦20 mol %, especially ≦10 mol %, more preferably ≦5 mol %, in relation to the contamination with elements of the third main group of the Periodic Table.

Therefore, before the admixing with triphenylmethyl chloride, the content of impurities in the halosilanes of technical-grade purity should be determined, more particularly the content of the elements of IIIa of the PTE and of any further impurities which form sparingly volatile and/or sparingly soluble complexes with triphenylmethyl chloride. These are especially the boron- and/or aluminium-containing compounds detailed above. The content can be determined, for example, by means of ICP-MS. Depending on the contents of these elements (IIIa PTE) and/or of any further impurities which react with triphenylmethyl chloride, the amount of triphenylmethyl chloride required can then be determined.

To date, in the prior art, triphenylmethyl chloride has been added in a distinct excess relative to the boron compounds present. In the process according to the invention, the amount of triphenylmethyl chloride required can be matched to the degree of contamination. In this way, it is possible to match the amount of triphenylmethyl chloride added, for example, more accurately to the solubility product of the sparingly soluble boron complexes in an environmentally benign manner. For better understanding of the procedure, reference is made to the details in the use examples.

The triphenylmethyl chloride can be added in process step a) by a single metered addition or else stepwise. According to the plant type or process regime, the addition can be effected in solid form or else dissolved in a solvent. The solvents used may be inert high-boiling solvents or preferably ultrahigh-purity halosilane, such as silicon tetrachloride and/or trichlorosilane. In this way, the metered addition of the triphenylmethyl chloride can be controlled very accurately and good mixing can be achieved within a short time.

Simultaneously with or after the admixing of the halosilanes of technical-grade purity with triphenylmethyl chloride in process step a), the reaction mixture can be treated thermally. The thermal treatment may, as stated at the outset, consist in heating, for example to coagulate the flocculant complexes and/or to complete the reaction. Alternatively, the reaction mixture can first be heated and then cooled in order to complete the reaction if appropriate and then to lower the solubility of the complexes further. The precipitated complexes are then removed from the cooled reaction mixture.

Preference is given to heating to bath temperatures of 30° C. to 100° C., preferably in the range from 50° C. to 85° C., in the course of which the flocculant precipitate increasingly coagulates together and floats on top of the halosilane. This is followed, preferably without stirring, by cooling and filtration, skimming-off, centrifugation or decantation. In one process alternative, the coagulated precipitate can be decanted off in a first step and the reaction mixture is subjected to a filtration only in a next step. In this way, the service life of the filter can be increased. In one embodiment, the admixing with triphenylmethyl chloride can be effected while stirring, optionally followed by heating of the reaction mixture, especially without stirring, which may be followed by the cooling of the reaction mixture, especially without stirring. This may be followed by a removal of the complexes by means of mechanical measures.

Useful filter media in the process according to the invention include especially membrane or absolute filters with mean pore diameters of ≦100 μm. Preference is given to filter media with mean pore diameters of ≦10 μm or ≦1 μm, particular preference being given to filter media with mean pore diameters of ≦0.2 μm. Smaller pore diameters, such as ≦0.10 μm or better ≦0.05 μm, especially ≦0.02 μm, can likewise be used, though consideration should be given to the pressures and pressure drops which increasingly have to be expended during the filtration.

According to the process regime, the inventive treatment of the halosilanes may first require careful drying of the triphenylmethyl chloride in order to prevent hydrolysis of the halosilanes to be purified when a purely mechanical removal of the sparingly soluble complex is formed, especially of the boron-containing complexes, is envisaged. Subsequently, the halosilanes are admixed with the dried triphenylmethyl chloride under a protective gas atmosphere, optionally while stirring. This is suitably followed by a thermal treatment under standard pressure over several hours.

Typically, the reaction mixture is treated for in the range from 5 minutes up to 10 hours, generally up to one hour. The recovery or removal to prepare the purified halosilanes is generally effected by filtration, centrifugation and/or decantation. As required, the process regime may be batchwise or continuous. A later distillative workup of the halosilanes is not affected by moisture, more particularly a small amount of residual moisture, because higher-boiling hydrolysis products of boron-containing compounds are formed preferentially and can be removed by distillation.

Examples 1a to 1d show that the boron content can be reduced directly after addition of the triphenylmethyl chloride by the mechanical removal of the sparingly soluble complexes. A certain residence time of the reaction mixture does not lead to any further reduction in the boron content in the purified halosilanes, especially the ultrahigh-purity halosilanes. Similarly, a thermal treatment of the reaction mixture in the manner of heating to complete the reaction is not absolutely necessary, although the heating does lead to an advantageous coagulation of the precipitates, which can more easily be removed mechanically.

The purified halosilanes prepared in this way, especially ultrahigh-purity halosilanes, preferably the ultrahigh-purity silicon tetrachloride and/or trichlorosilane, can be used to produce epitaxial layers, to produce silicon for the production of mono-, multi- or polycrystalline ingots or of wafers for production of solar cells or for production of ultrahigh-purity silicon for use in the semiconductor industry, for example in electronic components, or else in the pharmaceutical industry for preparation of SiO₂, for production of light waveguides or further silicon-containing compounds.

The invention further provides a plant (1) and the use thereof for reducing the content of elements of the third main group of the Periodic Table (IIIa PTE), especially the boron and/or aluminium content, in halosilanes of technical-grade purity to prepare purified halosilanes, comprising an apparatus for complexation (2) of compounds of these elements, to which is especially assigned a metering apparatus, and a separating unit (3) assigned to the apparatus for complexation; more particularly, the separating unit (3) comprises an apparatus which removes the precipitated complexes (precipitate) by means of mechanical action or mechanical measures on the halosilanes. The apparatus for complexation (2) and the separating unit may be directly connected to one another. For example, the apparatus (2), a reactor, may be attached directly to a separating unit (3), for example a filter. Ultrahigh-purity halosilanes can preferably be obtained with the plant.

In an alternative inventive plant (1), the separating unit (3) is connected downstream of at least one apparatus for complexation (2); more particularly, the separating unit (3) is separated from the apparatus for complexation (2). This allows integration of the plant (1) into an overall plant for preparing ultrahigh-purity halosilanes proceeding from a hydrohalogenation of metallurgical silicon, for example into a continuous overall plant. The apparatus for complexation (2) may have reactors connected in parallel and/or in series, such as batch reactors and/or tubular reactors, for semicontinuous or continuous complexation and homogenization of the reaction mixture, to which are assigned at least one downstream separating unit (3) for removal of the halosilanes from the complexes. According to the invention, the separating unit (3) comprises at least one apparatus which removes a precipitate of the complexes by means of mechanical action on the halosilanes, and optionally a distillation unit to which is assigned a distillation still, a column or a tubular evaporator and at least one distillation receiver.

An inventive separating unit (3) comprises, in particular, at least one filter unit, a decanting unit, an apparatus for skimming off floating precipitates and/or for removing sedimented precipitates, a centrifuging unit/centrifuge and optionally a distillation unit. The separating unit (3) may likewise have, in addition to a filter unit, decanting unit, an apparatus for skimming-off and/or a centrifuge, a downstream distillation column or tubular evaporator, and more particularly a dedicated distillation still and at least one distillation receiver to receive the ultrahigh-purity halosilanes, especially to receive fractions of the ultrahigh-purity halosilanes. According to the invention, a plurality of separating units may be connected in parallel or in series and/or arranged in a combination of series and parallel connection. Appropriately, different separating units may also be combined with one another, for example a centrifuge with a downstream filter.

The filters used may be sintered materials with suitable chemical stability, membrane filters and filter cartridges based on polymeric and possibly fibrous materials, wound filter cartridges, fabric filters, belt filters and all suitable designs of filters.

According to the invention, the filter unit comprises filter media with mean pore diameters of ≦100 μm. Preference is given to filter media with mean pore diameters of ≦10 μm or ≦1 μm, particular preference being given to filter media with mean pore diameters of ≦0.20 μm. Smaller pore diameters, such as ≦0.10 μm or better ≦0.05 μm, especially ≦0.02 μm, can likewise be used, though the apparatus should take account of the pressures or pressure drops which increasingly have to be expended during the filtration.

The filter media should generally be chemically stable with respect to the halosilanes to be purified and also with respect to any hydrolysis products which occur. Useful filter media include especially inorganic materials and/or inert organic materials, for example metals, activated carbon, zeolites, silicates and polymers, for example polymeric fluorocarbons, such as PTFE (polytetrafluoroethylene), PFA (perfluoroalkoxy (PFA)-substituted, fluorinated polymer), or organic polymers, such as PP (polypropylene), PE (polyethylene), PA (polyamide). Particular preference is given to a PTFE/PFA filter.

When the separating unit (3) has a distillation column, the latter will generally be a rectification column, at the top of which the distillatively purified product fractions of the ultrahigh-purity halosilanes, such as silicon tetrachloride and/or trichlorosilane, are obtained, while the soluble and/or sparingly volatile complexes remain in the distillation still. The plant can be operated in batch operation or continuously.

The plant (1) may be part of a larger plant which serves to prepare ultrahigh-purity halosilanes proceeding from metallurgical silicon; more particularly, the plant (1) is assigned to an overall plant comprising a reactor for conversion of metallurgical silicon.

The examples which follow illustrate the process according to the invention in detail, without restricting the invention to these examples.

### EXAMPLES

Determination of the boron content: The samples were prepared and analysed in a manner familiar to the skilled analyst, by hydrolysing the sample with demineralized water and treating the hydrolysate with hydrofluoric acid (superpure) to eliminate silicon in the form of volatile silicon tetrafluoride. The residue was taken up in demineralized water and the element content was determined by means of ICP-MS (ELAN 6000 Perkin Elmer).

### Example 1

### Preparation of Stock Solution

199.9 g of silicon tetrachloride were admixed with 0.010 g of triphenylmethyl chloride in a glass flask with a septum (0.005% suspension). A portion of the precipitate immediately formed settles out as sediment after about 10 minutes, whereas the supernatant liquid remains yellow and turbid.

### Example 1a

A suspension was prepared according to Example 1 and the addition of the complexing agent was followed immediately by filtration through a 0.45 μm Minisart® filter. Because the precipitate was in very fine particulate form, two filtrations were carried out. The filtration was carried out with a 10 ml syringe. The filtrate obtained was pale yellowish and had only slight turbidity.

### Example 1b

A suspension was prepared according to Example 1 and the addition of the complexing agent was followed 15 minutes later by a filtration with a 0.45 μm Minisart® filter on a 10 ml syringe. Owing to the fine precipitate, two filtrations were carried out. The filtrate obtained was pale yellowish and had only slight turbidity.

### Example 1c

30 minutes after addition of the complexing agent to form a suspension according to Example 1, a filtration was effected with a 0.45 μm Minisart® filter on a 10 ml syringe. Owing to the fine precipitate, two filtrations were carried out. The filtrate obtained was pale yellowish and had only slight turbidity.

TABLE 1
Boron content according to Examples 1, 1a, 1b and 1c

| | Boron content in μg/kg |
|---|---|
| Stock solution (1) | 214 |
| Filtration directly | 16 |
| after addition (1a) | |
| of complexing agent | |
| (triphenylmethyl | |
| chloride) | |
| Filtration 15 minutes | 18 |
| after addition of the | |
| complexing agent (1b) | |
| Filtration 30 minutes | 18 |
| after addition of the | |
| complexing agent (1c) | |

### Example 1d

A suspension was prepared according to Example 1 and filtered twice with a 0.2 μm Minisart® filter on a 10 ml syringe. The filtrate obtained in this way was clear and colourless. The boron content of the stock solution was reduced from originally 214 μg/kg to 17 μg/kg.

The boron content was reduced by a subsequent flash distillation to a content of less than 5 μg/kg after the distillation.

The distillation was effected under a nitrogen atmosphere with constant stirring by means of a magnetic stirrer. The heat was supplied by means of an oil bath with temperature control. The bath temperature during the distillation was approx. 80° C. and the temperature in the distillation still toward the end of the distillation was up to 60° C. The boiling point of the silicon tetrachloride was about 57° C. at standard pressure.

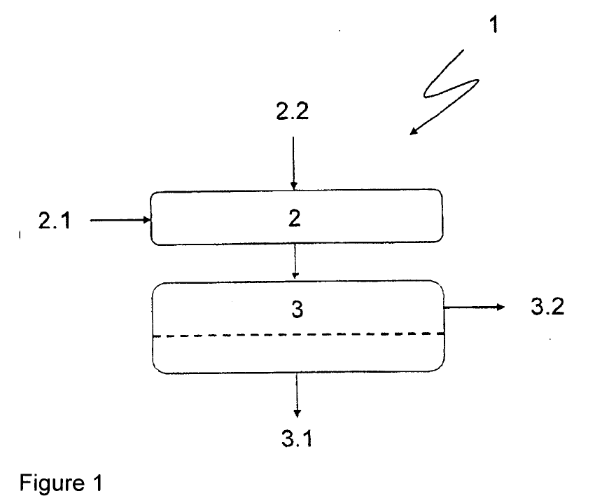

The inventive plant is illustrated in detail hereinafter with reference to the working example shown schematically in FIG. 1. The FIGURE shows:

FIG. 1: Schematic diagram of a plant with mechanical separating unit.

The plant (1) shown in FIG. 1 for reducing the content of elements of the third main group of the Periodic Table in halosilanes is manufactured from a material which is stable to the reaction conditions, for example from a stainless steel alloy. The plant (1) comprises a apparatus for complexation (2) of compounds containing these elements, and a separating unit (3) assigned to the apparatus (2). The apparatus for complexation (2) is generally a reactor, which may be a tank reactor or a tubular reactor, to which a separating unit (3) is assigned. As stated above, this separating unit (3) may have a filter unit and optionally a distillation unit. The separating unit (3) in FIG. 1 is a filter and is arranged downstream of the apparatus for complexation (2). The filter unit or a bundle of filter units may be arranged immediately below the reactor in order to utilize the geodetic head of the reaction mixture in the reactor.

In FIG. 1, the plant (1) is equipped with a feed (2.1), through which the halosilanes of technical-grade purity are passed into the apparatus for complexation (2); triphenylmethyl chloride can be added through a further feed (2.2). The reaction mixture formed can then be passed through a filter of the separating unit (3) in order to obtain purified halosilane (3.1). At (3.2), the complexes separated out by addition of triphenylmethyl chloride can be removed.

Alternatively, the separating unit (3) may additionally have a distillation unit, in which case the distillation unit has a distillation still, a column (rectifying column) with at least one separating plate or a tubular evaporator, and at least one distillation receiver to receive an ultrahigh-purity halosilane in each case (not shown). For exact metered addition of the amount of triphenylmethyl chloride, a metering apparatus (not shown) may be assigned to the complexing apparatus (2).

1. A process for reducing the content of elements of the third main group of the Periodic Table in at least one halosilane of technical-grade purity to prepare at least one purified halosilane, comprising:
(a) admixing at least one halosilane to be purified with triphenylmethyl chloride to form at least one complex which is sparingly soluble in the at least one halosilane in a reaction mixture,
(b) mechanically removing the at least one complex to obtain at least one purified halosilane.

2. The process according to claim 1,
wherein
the at least one complex is removed by centrifugation, skimming-off, decantation, sedimentation, and/or filtration.

3. The process according to claim 1,
wherein the admixing
(a) is effected in an apparatus for complexation, from which the at least one halosilane and the at least one complex is transferred at least partly into a separating unit for the mechanically removing in (b).

4. The process according to claim 1,
wherein
(a) and (b) are incorporated into a continuous process for preparing at least one ultrahigh-purity halosilane.

5. The process according to claim 1,
wherein
boron and/or aluminium content is reduced.

6. The process according to claim 1,
wherein
the at least one halosilane is a chlorosilane.

7. The process according to claim 6,
wherein
the at least one halosilane is tetrachlorosilane and/or trichlorosilane.

8. The process according to claim 1,
wherein
content of impurities is determined in the at least one halosilane of technical-grade purity which forms at least one complex with triphenylmethyl chloride.

9. The process according to claim 1,
wherein
triphenylmethyl chloride is added in (a) in such an amount that the solubility product of the at least one complex formed from compounds of elements of the third main group of the Periodic Table with triphenylmethyl chloride is exceeded and a precipitate of the at least one complex forms.

10. The process according to claim 1,
wherein
the triphenylmethyl chloride is added stepwise in (a).

11. The process according to claim 1,
wherein
the reaction mixture is treated thermally in (a) simultaneously with or after the admixing with triphenylmethyl chloride.

12. The process according to claim 1,
wherein removing
is effected with filter media having a mean pore diameter of ≦100 μm.

13. The process according to claim 1,
wherein
ultrahigh-purity halosilane is obtained.

14. The process according to claim 1,
wherein at least one
ultrahigh-purity halosilane, with a content of each element of the third main group of the Periodic Table of ≦50 μg/kg, is obtained.

15. The process according to claim 1,
wherein
the mechanically removing (b) of the at least one complex is followed by at least one distillation to obtain at least one high-purity halosilane.

16. The process according to claim 1,
wherein the mechanically removing (b)
of the at least one complex is followed by at least one distillation to obtain high-purity tetrachlorosilane, trichlorosilane and/or dichlorosilane.

17. The plant for reducing the content of elements of the third main group of the Periodic Table in at least one halosilane of technical-grade purity to prepare at least one purified halosilane, comprising
at least one complexation apparatus of at least one compound comprising these elements; and
a separating unit assigned to the at least one complexation apparatus, said separating unit comprising a removal apparatus which removes a precipitate of at least one complex by mechanical action on the at least one halosilane.

18. The plant according to claim 17,
wherein
the separating unit is connected downstream of at least one complexation apparatus.

19. The plant according to claim 17,
wherein
the separating unit comprises a centrifuging unit, a decanting unit, and/or a filter unit and a distillation unit.

20. The plant according to claim 19,
wherein
the distillation unit has a distillation still, a column, and at least one distillation receiver.

21. The plant according to claim 17,
wherein
a metering apparatus is assigned to the complexation apparatus.

22. The plant according to claim 17,
wherein
the plant is assigned to an overall plant comprising a reactor suitable for converting metallurgical silicon.

23. A method of producing at least one purified halosilane in the plant according to claim 17.
